(19) United States
(12) Patent Application Publication
(10) Pub. No.: US 2025/0280443 A1
(43) Pub. Date: Sep. 4, 2025

(54) OPERATION OF UHR SOFT-AP WITH SIGNALING OF UNAVAILABILITY PERIODS

(71) Applicant: APPLE INC., Cupertino, CA (US)

(72) Inventors: Neelakantan Nurani Krishnan, San Diego, CA (US); Qi Wang, Mountain View, CA (US); Yong Liu, Campbell, CA (US); Jarkko L. Kneckt, Los Gatos, CA (US); Anuj Batra, Redwood City, CA (US); Veerendra Boodannavar, Cupertino, CA (US)

(21) Appl. No.: 19/027,402

(22) Filed: Jan. 17, 2025

Related U.S. Application Data
(60) Provisional application No. 63/560,923, filed on Mar. 4, 2024.

(51) Int. Cl. H04W 74/0816; H04W 8/22; H04W 74/04

(52) U.S. Cl. CPC H04W 74/0816; H04W 8/22; H04W 74/04

(57) ABSTRACT

Embodiments herein provide systems, apparatuses, and methods for a soft-Access Point (AP) to signal an unavailability period to a station. A soft-AP may generate an Unavailability Announcement (UA) frame comprising an unavailability profile. The unavailability profile comprises information indicating an unavailability period for a soft-AP interface of the soft-AP. The soft-AP may send the UA frame to one or more stations associated with the soft-AP interface.

### TECHNICAL FIELD

This application relates generally to wireless communication systems, including a framework for a soft-access point to indicate periods of unavailability to a station.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. For example, Simultaneous Authentication of Equals is the core authentication protocol of WPA3-Personal, and is mandated to be supported by all Wi-Fi® Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an example timeline of the operation of a soft-AP in accordance with some embodiments.

FIG. 1B illustrates an example timeline of operation of an UHR soft-AP in accordance with some embodiments.

FIG. 2 illustrates an example UE that is operating as a soft-AP in accordance with some embodiments.

FIG. 3 illustrates an example signaling diagram of an STA attempting to send an uplink frame exchange to a soft-AP, in accordance with some embodiments.

FIG. 4 illustrates an example transmission timeline comprising an advertisement of unavailability, in accordance with some embodiments.

FIG. 5 illustrates an example timeline in which the TXOP duration requested by the UHR STA does not overlap with the soft-AP unavailability period, in accordance with some embodiments.

FIG. 6 illustrates an example timeline in which the TXOP duration requested by the UHR STA does overlap with the soft-AP unavailability period, and the UHR STA device is not capable of dynamically adjusting PPDU/TXOP, in accordance with some embodiments.

FIG. 7 illustrates an example timeline in which the TXOP duration requested by the UHR STA does overlap with the soft-AP unavailability period, and the UHR STA device is capable of dynamically adjusting PPDU/TXOP, in accordance with some embodiments.

FIG. 8 illustrates an example frame format of a UA frame, in accordance with some embodiments.

FIG. 9 illustrates an example transmission timeline in which the UHR soft-AP sends a management frame that includes a field indicating that unavailability periods are likely, in accordance with some embodiments.

FIG. 10 illustrates an example method performed by a soft-AP, in accordance with some embodiments.

FIG. 11 illustrates an example method performed by a STA, in accordance with some embodiments.

FIG. 12 illustrates an example system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is Institute of Electrical and Electronics Engineers (IEEE) 802.11 standard for Wireless Local Area Networks (WLAN) (commonly known to industry groups as Wi-Fi®). Wi-Fi® provides a convenient way to establish a network between devices. A device (e.g., a station) may connect to a Wi-Fi® access point to join a network and connect to the internet wirelessly. Wi-Fi® security is important to protect data and devices from unauthorized access.

Various embodiments are described with regard to a station (STA) (e.g., a user equipment (UE)) and Access Point (AP). However, reference to an STA and AP is merely provided for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

A soft access point (soft-AP) refers to a software-based access point that enables devices to connect to a wireless network. Unlike a traditional AP that operates using dedicated hardware, a soft-AP is implemented in software, allowing a device to emulate the functionality of a physical AP. Soft-APs are often used in scenarios where a physical access point is not available or practical, such as in mobile devices, laptops, or other systems requiring ad-hoc network capabilities. These software-based APs may facilitate the creation of wireless networks and support connectivity for multiple devices, providing a flexible and adaptable solution for wireless communication.

For example, a cellular phone may include a hot-spot functionality. When the hot-spot functionality is enabled, the cellular phone may function as a Wi-Fi AP that other devices can connect to and access the internet. The hot-spot functionality may be enabled by software.

Soft-APs can consume a significant amount of power, which can be detrimental to battery-operated devices. This increased power consumption is primarily due to the intensive processing and radio transmission operations to emulate the functions of a physical access point. As the soft-AP continuously processes and transmits data to facilitate wireless connectivity for multiple devices, it places a sustained demand on the device's battery. Moreover, the continuous operation of a soft-AP may prevent the device's radio components from entering low-power modes, further impacting battery life. This results in accelerated depletion of the device's battery. For battery-operated devices, the increased power consumption associated with soft-AP functionality poses a challenge in maintaining optimal battery life and user experience.

Therefore, mitigating the power consumption of soft-APs is crucial for ensuring efficient operation and prolonged battery life in such devices. Embodiments herein describe methods, systems, and apparatuses for optimizing operation of soft-APs.

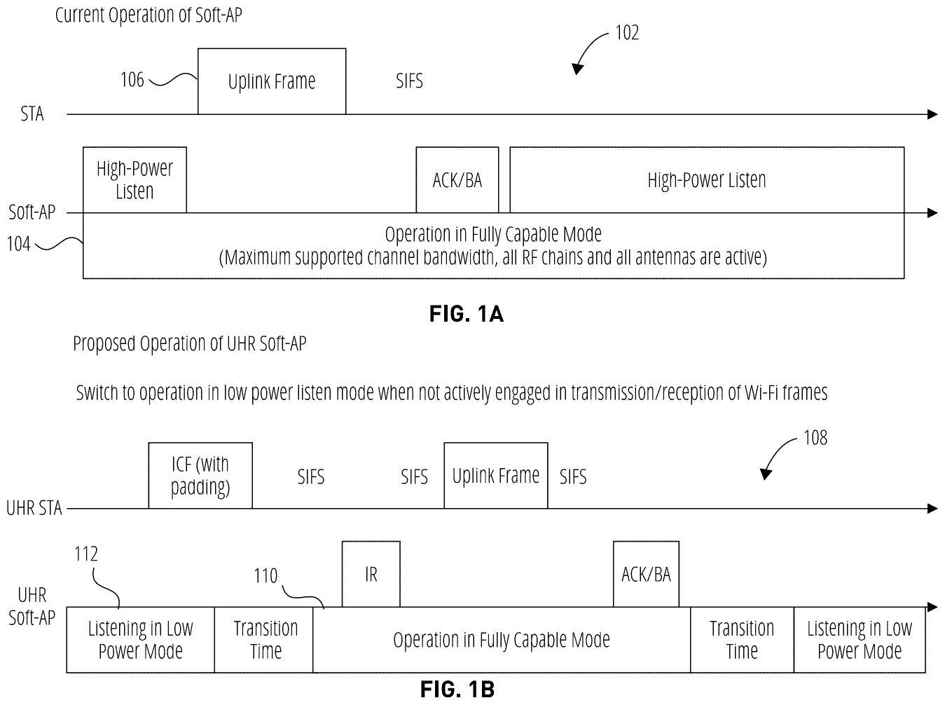

FIG. 1A illustrates an example timeline 102 of the operation of a soft-AP according to some embodiments. As shown, the soft-AP is always active and operating in fully capable mode 104. Operating in fully capable mode 104 means that the soft-AP is supporting the maximum supported channel bandwidth, and all RF chains and all antennas are active. In the illustrated configuration, the soft-AP is expected to be always on or always available by the associated devices. That means the soft-AP device will be consuming a lot of power all the time.

This ensures that the soft-AP is ready and able to receive to an uplink frame 106 from an associated STA. However, in this illustrated embodiment, even outside of useful frame exchanges with associated STAs, the soft-AP remains active wasting power. Accordingly, it may be desirable to allow the soft-AP to enter a lower power mode when not engaged in communications with the associated STAs.

For example, FIG. 1B illustrates an example timeline 108 of operation of an ultra-high reliability (UHR) soft-AP according to some embodiments. The UHR soft-AP is able to operate in both a fully capable mode 110 and a low power listen mode 112. The UHR soft-AP switches to operation in the low power listen mode 112 when not actively engaged in transmission/reception of Wi-Fi frames. The UHR soft-AP may switch to the fully capable mode 110 to exchange frames with an associated station. In low power listen mode 112, the soft-AP may use less power than when in fully capable mode 110. Some embodiments herein describe how to further optimize the use of low power listen mode 112, and the transition between the fully capable mode 110 and the low power listen mode 112.

A soft-AP may be implemented in different ways. For instance, in some embodiments, the soft-AP may comprise a single main radio that toggles between low-power listen mode and fully-capable mode. In some embodiments, the soft-AP may comprise use an auxiliary radio or scan radio for low-power listen mode and enable main radio for fully-capable mode. For a soft-AP, the radio(s) are likely shared with the STA interface and other interfaces in the same device. For example, in addition to the soft-AP interface and the STA interface, the radio(s) may be shared with in-device coexistence technologies like Bluetooth, Ultra wide band, etc.

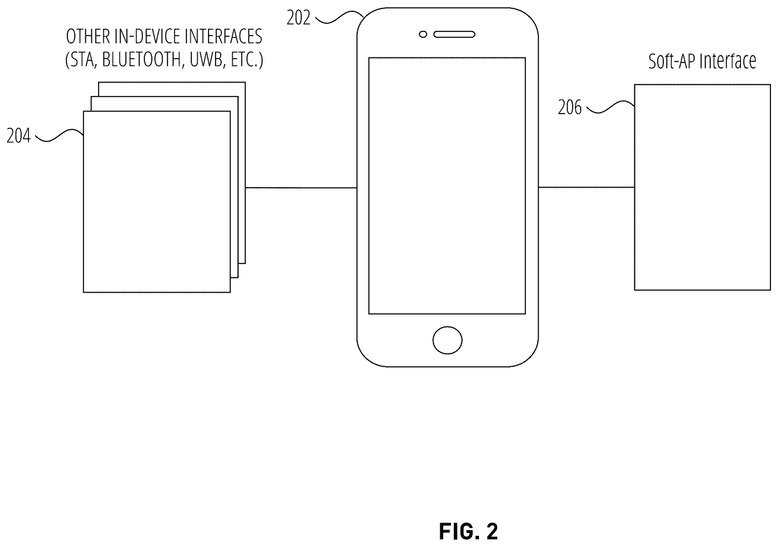

For example, FIG. 2 illustrates an example UE 202 that is operating as a soft-AP. The UE 202 acts as two different classes of devices. As shown in the illustrated embodiment, the UE 202 maintains both a soft-AP interface 206 and other in-device interfaces 204 (for example, Infra STA, In-device coexistence technologies like Bluetooth, Ultra Wideband, etc.). The UE 202 includes one or more radio(s) (e.g., scan radio and main radio) that are shared between the soft-AP interface 206 and other in-device interfaces 204.

Because of the multiple in-device interfaces sharing the same radio resources, there may be reasons for the soft-AP to be unavailable to associated devices. For example, when the scan or main radios are busy at one or more in-device interfaces 204, the soft-AP cannot serve its associated STAs concurrently over the soft-AP interface 206. Such soft-AP unavailability may be short-term, and may be periodic or aperiodic. Further, in some situations, the Soft-AP may choose to be unavailable for power-save reasons which may be long-term, periodic unavailability.

The scan radio may be used for high-priority operations in the other in-device interfaces 204 (e.g., STA interface, in-device coexistence technologies like Bluetooth, Ultra Wideband, etc.). For example, the scan radio may be used by the STA interface 204 for passive channel scans. Further, the scan radio may be used by the other in-device interfaces 204 for technologies like UWB, Thread, etc. The main radio may be busy with channel scans or In-device coexistence or peer-to-peer activities in the other in-device interfaces 204.

During these times when the other in-device interfaces 204 is using the radio resources, the STAs associated with the soft-AP may not be able to use the soft-AP interface 206. Accordingly, it may be desirable to have a framework for UHR Soft-AP to advertise short-term unavailability schedules, if known, to the associated UHR STAs. One benefit of such a framework is that it may prevent UHR STAs from initiating frame exchange to UHR Soft-AP when the UHR Soft-AP is unavailable.

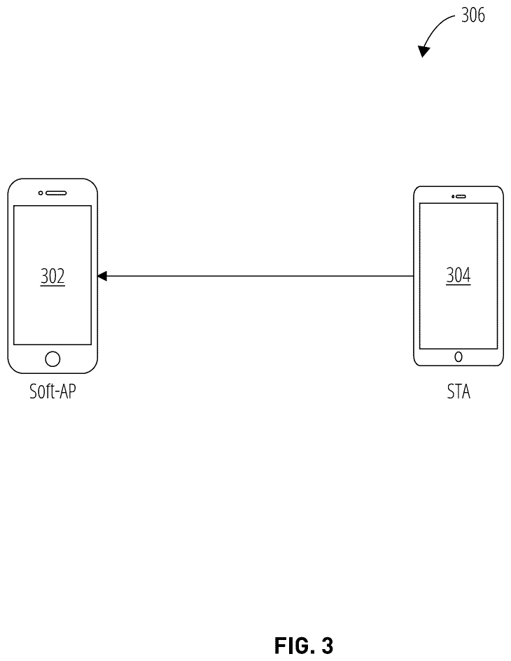

FIG. 3 illustrates an example signaling diagram 306 of an STA 304 attempting to send an uplink frame exchange to a soft-AP 302. Signaling of unavailability periods from a soft-AP 302 may benefit both the soft-AP 302 as well as the STA 304.

For instance, if the STA 304 is not apprised of the unavailability of the soft-AP 302, then the STA 304 may persistently initiate uplink frame exchanges with soft-AP 302 while it is unavailable. This will lead to successive frame failures in the uplink due to the unavailability of the soft-AP 302. The STA 304 may adopt undesirable steps because of frame failure(s). For example, the STA 304 may drop to a lower data rate and/or drop packet(s). Further, the lower data rate for uplink transmission may lead to a longer duration to transmit the pending data payload. This may cause the soft-AP 302 to spend more time in active receive state resulting in higher energy consumption at the soft-AP 302. These effects may be exacerbated when the soft-AP 302 is unavailable for a substantial period of time (e.g., long Coex/P2P/roaming scans, tens of millisecond long).

The signaling of unavailability may also benefit the STA 304. If the STA 304 is not aware of the unavailability schedule of soft-AP 302, then several successive uplink frames from the STA 304 to the soft-AP 302 may fail. The STA 304 may invoke rate adaptation and drop to a lower rate, because of uplink frame failure(s), resulting in poor uplink latency performance, and longer active transmission time to flush out uplink payload. This may result in higher energy consumption for the STA 304. The STA 304 may choose to drop packets because of breaching a retry limit. There may be an increased energy consumption at STA because of persistent ICF transmissions. The STA may double its contention window after each frame failure resulting in longer channel access delay. The medium may be flooded by gratuitous ICFs, especially if multiple STAs are associated with the Soft-AP. Long duration of unavailability at Soft-AP can compound these problems. These effects may be exacerbated when the soft-AP unavailability extends for a substantial period of time.

Some embodiments herein provide a framework to prevent or reduce such undesirable effects. For example, some embodiments include signaling of unavailable periods from the soft-AP 302. Signaling of unavailability periods from soft-AP 302 may benefit devices acting as a soft-AP as well as a STA.

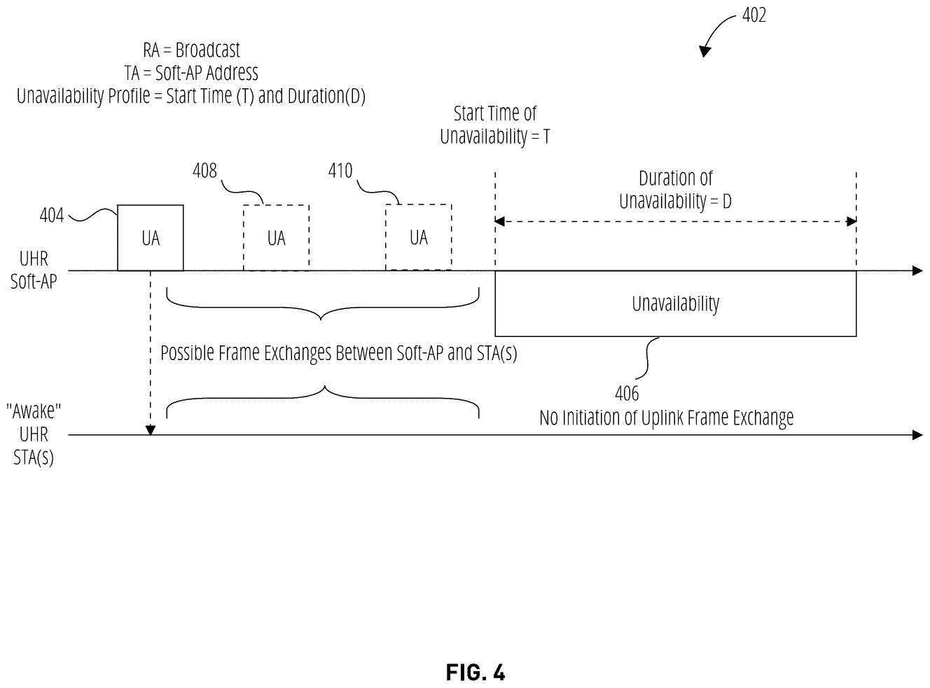

FIG. 4 illustrates an example transmission timeline 402 comprising an advertisement of unavailability, in accordance with some embodiments. A soft-AP may broadcast an advertisement to indicate to the associated STAs of aperiodic short-term unavailability. In some embodiments, the soft-AP unavailability may not be deterministic or periodic, and may be known only a short-time in advance.

As shown, a UHR soft-AP may send a frame to the associated STAs to indicate the soft-AP unavailability period 406. Signaling of unavailability schedule may be sent in a new control frame called Unavailability Announcement (UA) (e.g., UA frame 404). The UA frame 404 may be broadcast by the soft-AP to all associated STAs. For example, the receiver address field of the UA frame 404 may be set to broadcast address (i.e., RA=Broadcast address). UHR Soft-AP sends UA frame (RA=Broadcast address) with information about an upcoming unavailability period (start time and duration).

As shown, the UA frame 404 may include an RA field set to broadcast. The UA frame 404 may also include a Transmitter Address (TA) field set to the soft-AP address that transmitted the UA frame 404. The TA field may help the STAs in identifying the sender of the UA frame 404 within the wireless network. The UA frame 404 may also include an unavailability profile. The unavailability profile may include the start time of the unavailability period 406, and a duration of the unavailability period 406.

All awake associated UHR STAs (e.g., not in power-save mode) receive the UA frame 404. The UHR STAs use the received UA frame 404 to determine the start and duration of the upcoming unavailability period 406. Thus, using the UA frame 404, the UHR STAs are aware of the forthcoming unavailability of the soft-AP. The UHR STA refrains from initiating any uplink frame exchanges during the unavailability period 406 signaled by soft-AP in the UA frame 404. The UHR STA may exchange frames with the UHR soft-AP before or after the unavailability period 406.

In some embodiments, to improve robustness of the signaling, the soft-AP may choose to transmit the UA frame 404 multiple times. For example, in the illustrated embodiment, the soft-AP optionally sends the UA frame 404, a second UA frame 408, and a third UA frame 410. In some embodiments the multiple UA frames may be periodic. The multiple transmissions allow for a higher chance that the UHR STAs can receive the information.

In some embodiments, request-response signaling may be used to indicate the soft-AP availability. For example, a UHR STA may transmit a request to the soft-AP, and the soft-AP may respond to the UHR with an information related to an upcoming unavailability period (e.g., a UA frame). In some embodiments, the UHR STAs shall initiate each Transmission Opportunity (TXOP) with an initial control frame (ICF) unicast to soft-AP. The UHR soft-AP may indicate the upcoming unavailability profile in the UA frame as a response to the ICF received from UHR STA. The unavailability profile may include start time and duration for a period of unitability for the soft-AP. In some embodiments, the UA frame may be broadcast addressed so that all awake associated UHR STAs become aware of the imminent unavailability. The UHR STA(s) may refrain from initiating any uplink frame exchanges during the unavailability period signaled by Soft-AP in the UA frame.

Additionally, for such a request-response signaling framework, the soft-AP may adjust its response based on the capability of the UHR STA. Some UHR STAs may not be capable of adjusting PPDU/TXOP duration based on the unavailability profile received in UA frame. Some UHR STA are capable of dynamically adjusting PPDU/TXOP duration based on the unavailability profile signaled in UA frame. The UA frame response may differ based on the capability of the STA.

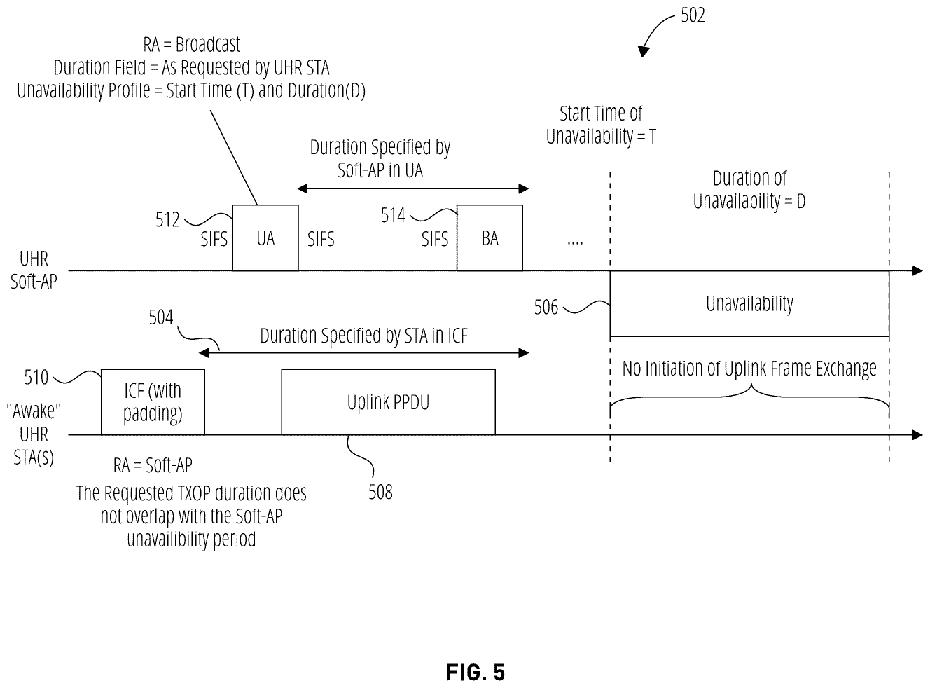

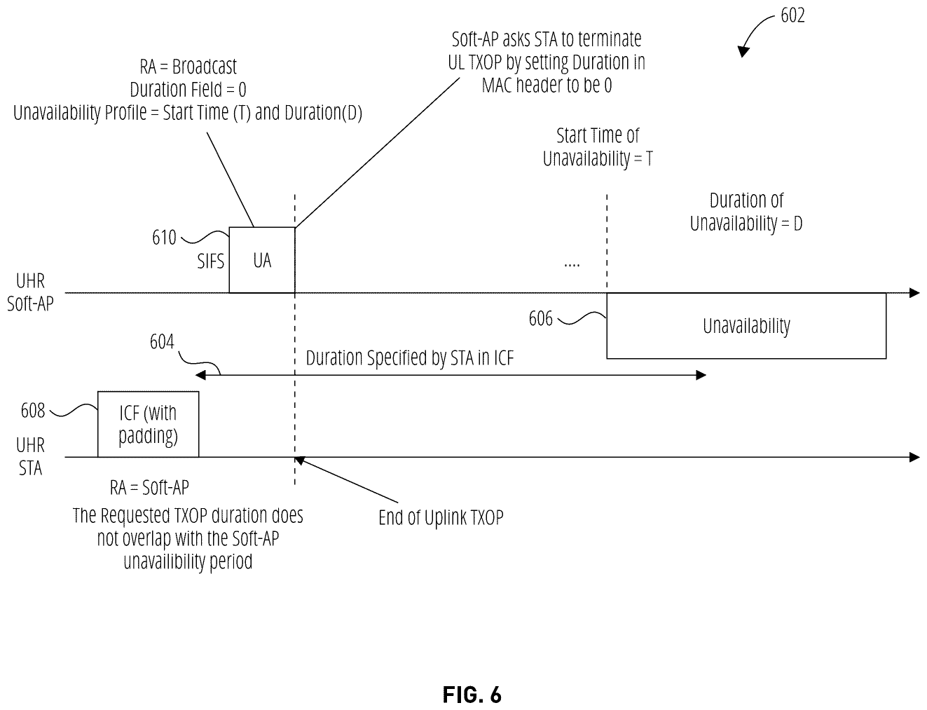

For example, FIG. 5 and FIG. 6 illustrate two example transmission timelines for a UHR soft-AP in communication with a UHR STA that is not capable of dynamically adjusting PPDU/TXOP. Specifically, FIG. 5 illustrates an example timeline 502 in which the TXOP duration 504 requested by the UHR STA does not overlap with the soft-AP unavailability period 506. FIG. 6 illustrates an example timeline 602 in which the TXOP duration 604 requested by the UHR STA does overlap with the soft-AP unavailability period 606.

Referring to FIG. 5, in cases where the UHR STA is not capable of dynamically adjusting PPDU/TXOP and the uplink TXOP duration 504 does not overlap with Soft-AP unavailability period 506, the soft-AP may allow the UHR STA to transmit the uplink PPDU frame 508. Whenever the STA wants to initiate an uplink frame exchange it may send an ICF 510. The ICF 510 may request the uplink TXOP duration 504. In the illustrated embodiment, the UHR soft-AP receives the ICF 510 and determines that the UHR STA is not capable of dynamically adjusting PPDU/TXOP. The UHR soft-AP may determine whether the uplink TXOP duration 504 does not overlap with Soft-AP unavailability period 506.

In FIG. 5 the UHR soft-AP determines that the uplink TXOP duration 504 does not overlap with Soft-AP unavailability period 506. The UHR soft-AP transmits a UA 512 in response to the ICF 510. Because the uplink TXOP duration 504 does not overlap with Soft-AP unavailability period 506, the soft-AP may set the duration field of the UA 512 to the period of time requested by UHR STA. The UA 512 may also include the unavailability profile with the start time and duration for the Soft-AP unavailability period 506. Because the duration field is set to the requested time, the UHR STA may proceed with sending the uplink PPDU frame 508 to the UHR soft-AP. The UHR soft-AP may send a Block Acknowledgment (BA) frame 514 in response. The UHR STA may determine the Soft-AP unavailability period 506 based on the unavailability profile in the UA 512. During the Soft-AP unavailability period 506, the UHR STA abstains from initiating an uplink frame exchange.

Referring to FIG. 6, in cases where the UHR STA is not capable of dynamically adjusting PPDU/TXOP and the uplink TXOP duration 604 does overlap with Soft-AP unavailability period 606, the soft-AP may ask the STA to terminate the uplink TXOP. Whenever the STA wants to initiate an uplink frame exchange it may send an ICF 608. The ICF 608 may request the uplink TXOP duration 604. In the illustrated embodiment, the UHR soft-AP receives the ICF 608 and determines that the UHR STA is not capable of dynamically adjusting PPDU/TXOP. The UHR soft-AP may determine whether the uplink TXOP duration 604 as requested in the ICF overlaps with Soft-AP unavailability period 606.

In FIG. 6 the UHR soft-AP determines that the uplink TXOP duration 604 overlaps with Soft-AP unavailability period 606. The UHR soft-AP transmits a UA 610 in response to the ICF 608. Because the uplink TXOP duration 604 overlaps with the Soft-AP unavailability period 606, the soft-AP may set the duration field in MAC header of the UA 610 to zero. Setting the duration field to zero may indicate to the STA to terminate the UL TXOP. The UA 610 may also include the unavailability profile with the start time and duration for the Soft-AP unavailability period 606. Because the duration field is set to zero, the UHR STA may terminate the uplink UL TXOP. The UHR STA may determine the Soft-AP unavailability period 606 based on the unavailability profile in the UA 610. During the Soft-AP unavailability period 606, the UHR STA abstains from initiating an uplink frame exchange.

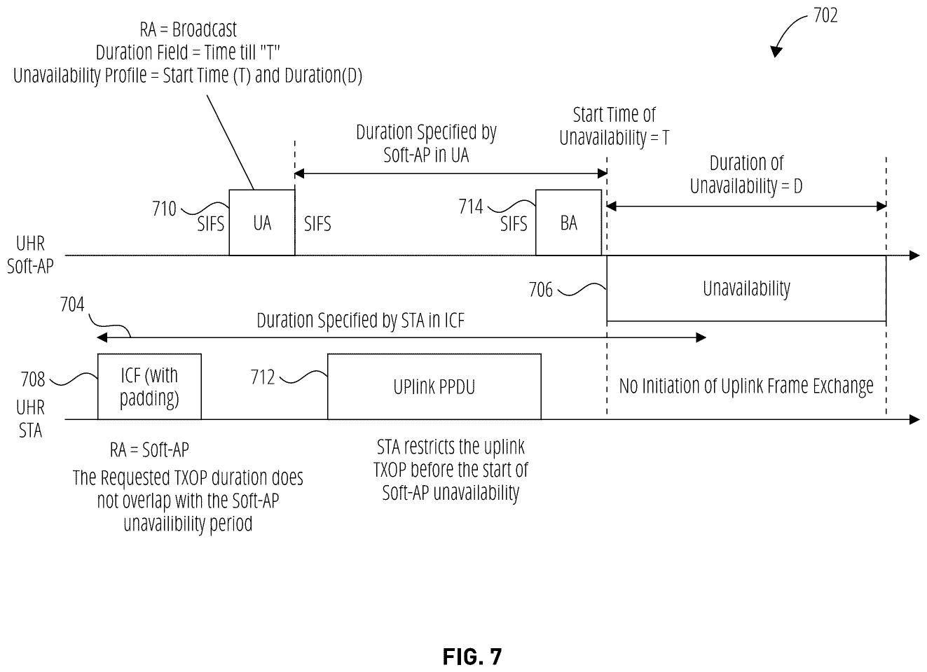

Some UHR STA devices may be capable of dynamically adjusting PPDU/TXOP. FIG. 7 illustrates an example timeline 702 in which the TXOP duration 704 requested by the UHR STA does overlap with the soft-AP unavailability period 706, and the UHR STA device is capable of dynamically adjusting PPDU/TXOP. Whenever the STA wants to initiate an uplink frame exchange it may send an ICF 708. The ICF 708 may request the uplink TXOP duration 704.

In the illustrated embodiment, the UHR soft-AP receives the ICF 708 and determines that the UHR STA is capable of dynamically adjusting PPDU/TXOP. The UHR soft-AP may determine whether the uplink TXOP duration 704 as requested in the ICF overlaps with Soft-AP unavailability period 706. In the illustrated example, the UHR soft-AP determines that the uplink TXOP duration 704 overlaps with Soft-AP unavailability period 706. Based on the UHR STA capability, the UHR soft AP may generate a UA 710 that includes a duration field set to the time until the start of the soft-AP unavailability period 706. Setting the duration field of the UA 710 based on the time until the soft-AP unavailability period 706 starts truncates the TXOP so that it ends before the e soft-AP unavailability period 706 begins. The UA 710 may also include the unavailability profile with the start time and duration for the Soft-AP unavailability period 706.

The UHR soft-AP transmits the UA 710 in response to the ICF 708. The UHR receives the UA 710, and determines based on the duration field that the uplink TXOP duration has been reduced. The STA restricts the uplink TXOP before the start of Soft-AP unavailability. During the truncated duration, the UHR STA sends the uplink PPDU frame 712 to the UHR soft-AP. The UHR soft-AP may send a BA frame 714 in response. The UHR STA may determine the Soft-AP unavailability period 706 based on the unavailability profile in the UA 710. During the Soft-AP unavailability period 706, the UHR STA abstains from initiating an uplink frame exchange.

In some embodiments (e.g., embodiments shown in FIGS. 6-8), the UHR STA can indicate to the UHR soft-AP that it is capable of dynamically adjusting PPDU/TXOP duration, based on unavailability profile received from Soft-AP, after the TXOP has been initiated. In some embodiments, such a signaling may be achieved by setting a capability field at the time of association, or at some other time. The UHR soft-AP may perform the sequence in FIG. 7 if the UHR STA has explicitly indicated capability to dynamically adjust uplink PPDU/TXOP duration. Otherwise, the soft-AP can follow the sequences described in FIG. 5 and FIG. 6.

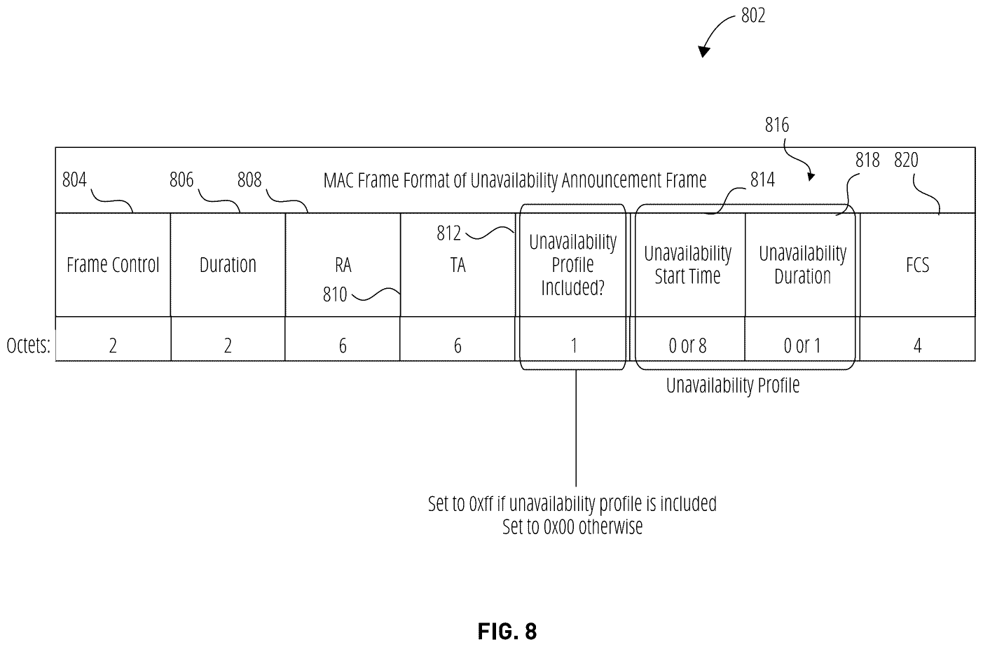

FIG. 8 illustrates an example frame format of a UA frame 802 in accordance with some embodiments. A soft-AP may generate the UA frame 802, and send the UA frame 802 to a UHR STA to inform the UHR STA of an upcoming unavailability period. As shown, the UA frame 802 may include a frame control field 804. The frame control field 804 may include control information to manage the transmission and reception of the UA frame 802. The UA frame 802 may also include a duration field 806. The duration field 806 may indicate a duration available for uplink from the UHR STA.

As shown, the UA frame 802 may also include address fields. For example, the UA frame 802 may include a Receiver Address field (RA field 808) to direct the frame to the appropriate STA within the wireless network. The UA frame 802 may include a TA field 810 set to the soft-AP address that transmitted the UA frame 802.

The UA frame 802 may also include an unavailability profile inclusion field 812. The unavailability profile inclusion field 812 may indicate whether or not the UA frame 802 includes an unavailability profile 816. For instance, in some embodiments, the soft-AP may set the unavailability profile inclusion field 812 to 0Xff if the unavailability profile 816 is available, and may set the unavailability profile inclusion field 812 to 0X00 if the unavailability profile 816 is not available.

The unavailability profile 816 may include an unavailability start time field 814 and an unavailability duration field 818. The unavailability start time field 814 may indicate the start time for an upcoming period where the soft-AP will be unavailable. The unavailability duration field 818 may indicate the duration for an upcoming period where the soft-AP will be unavailable. Additionally, the UA frame 802 may include a frame check sequence (e.g., FCS field 820).

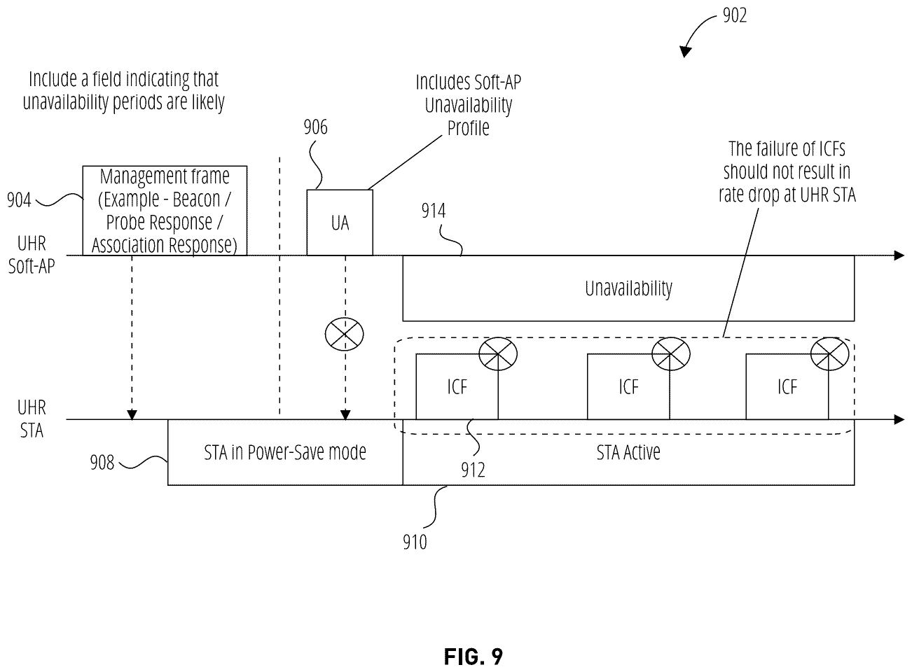

In some embodiments, the UHR soft-AP may also provide an indication that unavailability periods are likely on a frame outside of the UA frame. For instance, FIG. 9 illustrates an example transmission timeline 902 in which the UHR soft-AP sends a management frame 904 (e.g., beacon, probe response, association response, or any other frames) that includes a field indicating that unavailability periods are likely, in accordance with some embodiments. Previously described embodiments work if the associated UHR STAs are active (not in power-save state). Such embodiments may be enhanced to better support STAs that are in power-saving state when a UE frame is sent.

It is likely that some associated UHR STAs are in power-state when the soft-AP advertises its upcoming unavailability (in the UA frame 906). Such STAs may initiate uplink transmission to the soft-AP when the soft-AP is unavailable and hence fail. As described previously the UHR STAs may be required to initiate each uplink TXOP with an ICF.

To prevent undesirable affects (e.g., drop to a lower data rate and/or drop packet(s)) the following may be implemented. The soft-AP can indicate to UHR STA(s) about the possibility of unavailability periods in the session. This indication could be provided before association (through beacons/probe response frames), at the time of association (through association response frames), or after association (through beacon frames). If the unavailability indication has been received from Soft-AP, then the UHR STAs should not consider lack of response to an ICF as a trigger for rate/packet drops.

For instance, as illustrated in FIG. 9, the UHR soft-AP may send a management frame 904 to the UHR STA. The management frame 904 may include a field indicating that unavailability periods are likely. When the UHR STA receives the management frame 904 from the UHR soft-AP it may determine the likelihood of unavailability periods for the UHR soft-AP based on the included field. If the field indicates that the soft-AP is not likely to have unavailability periods, then if there is a lack of response to ICF the UHR STA may perform rate/packet drops. If the field indicates that the soft-AP is likely to have unavailability periods, then if there is a lack of response to ICF the UHR STA does not consider lack of response to an ICF as a trigger for rate/packet drops.

For example, in FIG. 9 the field in the management frame 904 transmitted by UHR soft-AP indicates that unavailability periods are likely. In the illustrated example, the UHR STA enters a power-save mode 908, and the UHR soft-AP sends a UA frame 906 while the UHR STA is in the power-save mode 908. Because of the power-save state of the UHR STA, the UHR STA fails to receive the UA frame 906. The UHR STA enters an active state 910, and transmits one or more ICFs 912. The UHR soft-AP fails to send a response to the ICF as the UHR soft-AP is in a period of unavailability 914. Because of the previous indication by Soft-AP about the unavailability through the management frame 904, the failure of ICFs should not result in rate drop or packet drop at the UHR STA.

As described herein, it is desirable to devise schemes that enable a UHR Soft-AP to advertise unavailability schedules (both short and long term) to UHR STAs. The unavailability may stem from critical operations in other interfaces (channel scans in STA interface, in-device coexistence activities, peer-to-peer events, etc.). One benefit of such advertisement is preventing UHR STAs from initiating frame exchanges with the Soft-AP when the latter is unavailable. Embodiments herein propose mechanisms to accomplish signaling of short-term (or near-term) aperiodic unavailability. In some embodiments, a short-term unavailability announcement is made using a broadcast control frame (e.g., Unavailability Announcement). In some embodiments, a short-term unavailability signaling may be performed through a request-response frame exchange.

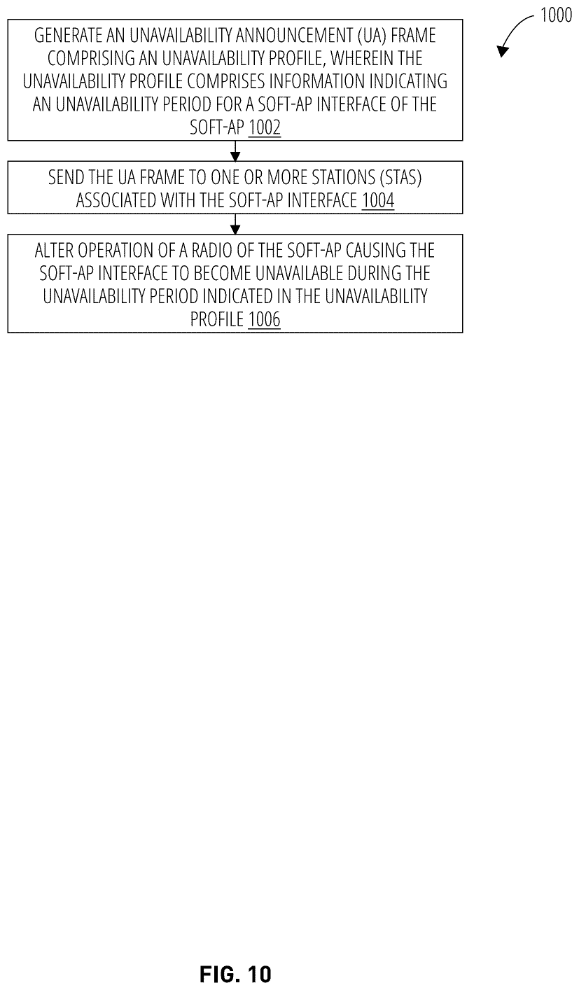

FIG. 10 illustrates an example method 1000 performed by a soft-AP, in accordance with some embodiments. The illustrated method includes generating 1002 a UA frame comprising an unavailability profile, wherein the unavailability profile comprises information indicating an unavailability period for a soft-AP interface of the soft-AP. The method 1000 further comprises sending 1004 the UA frame to one or more STAs associated with the soft-AP interface. The method 1000 further comprises altering 1006 operation of a radio of the soft-AP causing the soft-AP interface to become unavailable during the unavailability period indicated in the unavailability profile.

In some embodiments, the method 1000 further comprises sending the UA frame multiple times before the unavailability period.

In some embodiments, the unavailability profile comprises a start time and a duration for the unavailability period.

In some embodiments, the method 1000 further comprises receiving, from one of the STAs, an ICF specifying a requested TXOP duration, wherein the UA frame is sent in response to the ICF.

In some embodiments, the UA frame is an unsolicited broadcast.

In some embodiments, the method 1000 further comprises receiving, from a first STA, an indication that the first STA is capable of dynamically adjusting a TXOP duration and a PPDU duration, after a TXOP has been initiated.

In some embodiments, the indication comprises a capability field that is sent during association.

In some embodiments, the method 1000 further comprises determining, when the first STA is not capable of dynamically adjusting, if a requested TXOP duration specified by the first STA in an ICF overlaps the unavailability period; if the requested TXOP duration overlaps the unavailability period, setting a duration field of the UA frame to zero to terminate an uplink TXOP; and if the requested TXOP duration does not overlap the unavailability period, setting the duration field of the UA frame to the requested TXOP duration.

In some embodiments, the method 1000 further comprises setting, when the first STA is capable of dynamically adjusting, a duration field in the UA frame to a time until a start of the unavailability period a requested TXOP duration specified by the STA in an ICF overlaps the unavailability period.

In some embodiments, the UA frame includes a field that indicates if the unavailability profile is included.

In some embodiments, the method 1000 further comprises transmitting an indication in beacons about a likelihood of future unavailability periods.

Embodiments contemplated herein include an apparatus comprising means to perform one or more elements of the method 1000. This apparatus may be, for example, an apparatus of an AP (such as an AP 1218, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of an AP (such as a memory 1222 of an AP 1218, as described herein).

Embodiments contemplated herein include an apparatus comprising logic, modules, or circuitry to perform one or more elements of the method 1000. This apparatus may be, for example, an apparatus of an AP (such as an AP 1218, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of an AP (such as an AP 1218, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of an AP (such as a processor(s) 1220 of an AP 1218, as described herein). These instructions may be, for example, located in the processor and/or on a memory of the AP (such as a memory 1222 of an AP 1218, as described herein).

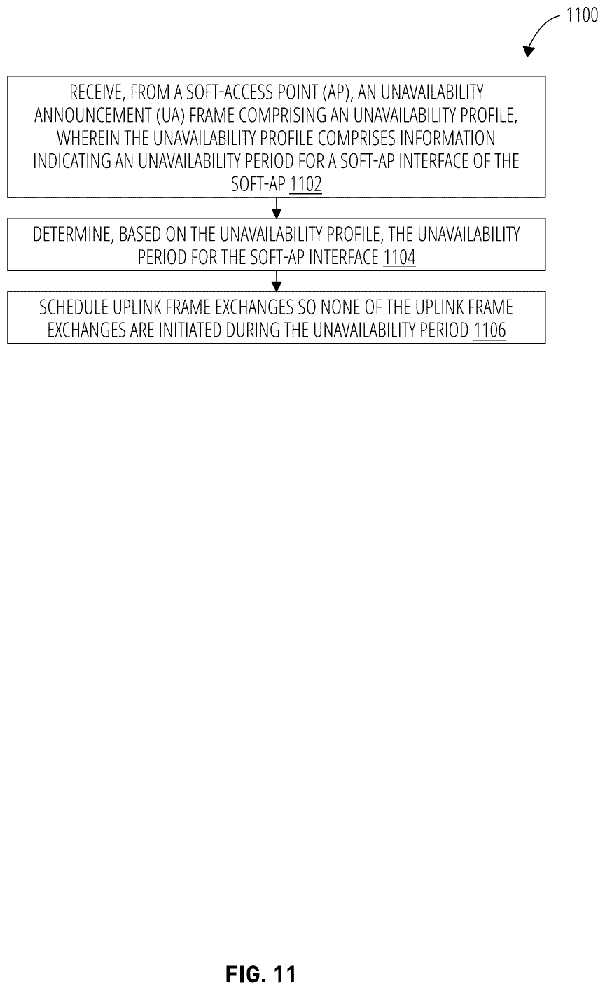

FIG. 11 illustrates an example method 1100 performed by an STA, in accordance with some embodiments. The method 1100 comprises receiving 1102, from a soft-AP, a UA frame comprising an unavailability profile, wherein the unavailability profile comprises information indicating an unavailability period for a soft-AP interface of the soft-AP. The method 1100 further comprises determining 1104, based on the unavailability profile, the unavailability period for the soft-AP interface. The method 1100 further comprises scheduling 1106, uplink frame exchanges so none of the uplink frame exchanges are initiated during the unavailability period.

In some embodiments, the method 1100 further comprises receiving the UA frame multiple times before the unavailability period.

In some embodiments, the unavailability profile comprises a start time and a duration for the unavailability period.

In some embodiments, the method 1100 further comprises sending, to the soft-AP, an ICF specifying a requested TXOP duration, wherein the UA frame is sent in response to the ICF.

In some embodiments, the UA frame is an unsolicited broadcast.

In some embodiments, the method 1100 further comprises sending, to the soft-AP, an indication that the STA is capable of dynamically adjusting a TXOP duration and a PPDU duration, after a TXOP has been initiated.

In some embodiments, the indication comprises a capability field that is sent during association.

In some embodiments, when the STA is not capable of dynamically adjusting, and if a requested TXOP duration specified by the STA in an ICF overlaps the unavailability period, a duration field of the UA frame is set to zero to terminate an uplink TXOP if the requested TXOP duration overlaps the unavailability period, and the duration field of the UA frame is set to the requested TXOP duration if the requested TXOP duration does not overlap the unavailability period.

In some embodiments, when the STA is capable of dynamically adjusting, a duration field in the UA frame is set to a time until a start of the unavailability period when a requested TXOP duration specified by the STA in an ICF overlaps the unavailability period.

In some embodiments, the UA frame includes a field that indicates if the unavailability profile is included.

In some embodiments, the method 1100 further comprises receiving, from the soft-AP, an indication in a beacon about a likelihood of future unavailability periods.

Embodiments contemplated herein include an apparatus comprising means to perform one or more elements of the method 1100. This apparatus may be, for example, an apparatus of an STA (such as STA 1202 as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of an STA (such as a memory 1206 of an STA 1202, as described herein).

Embodiments contemplated herein include an apparatus comprising logic, modules, or circuitry to perform one or more elements of the method 1100. This apparatus may be, for example, an apparatus of an STA (such as an STA 1202, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of an STA (such as an STA 1202, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of an STA (such as a processor(s) 1204 of an STA 1202, as described herein). These instructions may be, for example, located in the processor and/or on a memory of the STA (such as a memory 1206 of an STA 1202, as described herein).

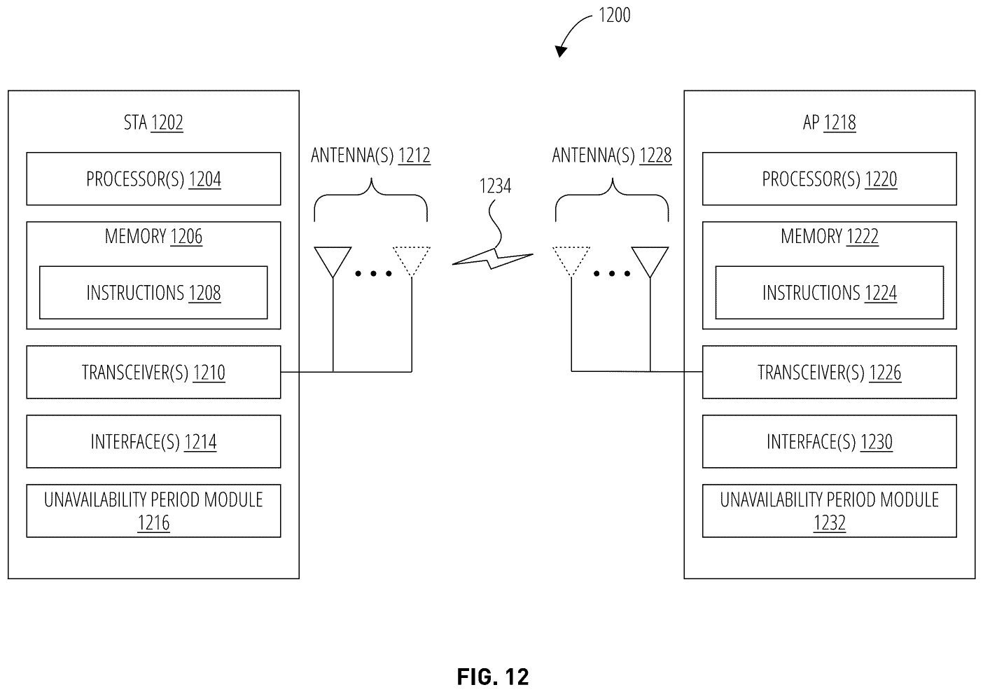

FIG. 12 illustrates a system 1200 for performing signaling 1234 between an STA 1202 and an AP 1218, according to embodiments disclosed herein. The system 1200 may be a portion of a wireless communications system as herein described. The STA 1202 may be, for example, a UE of a wireless communication system. The AP 1218 may be, for example, an access point of a wireless communication system, or a soft-AP.

The STA 1202 may include one or more processor(s) 1204. The processor(s) 1204 may execute instructions such that various operations of the STA 1202 are performed, as described herein. The processor(s) 1204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 1202 may include a memory 1206. The memory 1206 may be a non-transitory computer-readable storage medium that stores instructions 1208 (which may include, for example, the instructions being executed by the processor(s) 1204). The instructions 1208 may also be referred to as program code or a computer program. The memory 1206 may also store data used by, and results computed by, the processor(s) 1204.

The STA 1202 may include one or more transceiver(s) 1210 that may include radio frequency (RF) transmitter circuitry and/or receiver circuitry that use the antenna(s) 1212 of the STA 1202 to facilitate signaling (e.g., the signaling 1234) to and/or from the STA 1202 with other devices (e.g., the AP 1218).

The STA 1202 may include one or more antenna(s) 1212 (e.g., one, two, four, or more). For embodiments with multiple antenna(s) 1212, the STA 1202 may leverage the spatial diversity of such multiple antenna(s) 1212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 1202 may be accomplished according to precoding (or digital beamforming) that is applied at the STA 1202 that multiplexes the data streams across the antenna(s) 1212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the STA 1202 may implement analog beamforming techniques, whereby phases of the signals sent by the antenna(s) 1212 are relatively adjusted such that the (joint) transmission of the antenna(s) 1212 can be directed (this is sometimes referred to as beam steering).

The STA 1202 may include one or more interface(s) 1214. The interface(s) 1214 may be used to provide input to or output from the STA 1202. For example, an STA 1202 that is a UE may include interface(s) 1214 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1210/antenna(s) 1212 already described) that allow for communication between the UE and other devices and may operate according to known protocols (e.g., Wi-Fi®, Bluetooth®, and the like).

The STA 1202 may include an unavailability period module 1216. The unavailability period module 1216 may be implemented via hardware, software, or combinations thereof. For example, the unavailability period module 1216 may be implemented as a processor, circuit, and/or instructions 1208 stored in the memory 1206 and executed by the processor(s) 1204. In some examples, the unavailability period module 1216 may be integrated within the processor(s) 1204 and/or the transceiver(s) 1210. For example, the unavailability period module 1216 may be implemented by a combination of software components (e.g., executed by a DSP or a general processor) and hardware components (e.g., logic gates and circuitry) within the processor(s) 1204 or the transceiver(s) 1210.

The unavailability period module 1216 may be used for various aspects of the present disclosure, for example, aspects of FIGS. 1-12. The unavailability period module 1216 is configured to determine periods of unavailability of a soft-AP (e.g., AP 1218) based on a UA frame.

The AP 1218 may include one or more processor(s) 1220. The processor(s) 1220 may execute instructions such that various operations of the AP 1218 are performed, as described herein. The processor(s) 1220 may include one or more baseband processors implemented using, for example, a CPU, a DSP, an ASIC, a controller, an FPGA device, another hardware device, a firmware device, or any combination thereof configured to perform the operations described herein.

The AP 1218 may include a memory 1222. The memory 1222 may be a non-transitory computer-readable storage medium that stores instructions 1224 (which may include, for example, the instructions being executed by the processor(s) 1220). The instructions 1224 may also be referred to as program code or a computer program. The memory 1222 may also store data used by, and results computed by, the processor(s) 1220.

The AP 1218 may include one or more transceiver(s) 1226 that may include RF transmitter circuitry and/or receiver circuitry that use the antenna(s) 1228 of the AP 1218 to facilitate signaling (e.g., the signaling 1234) to and/or from the AP 1218 with other devices (e.g., the STA 1202).

The AP 1218 may include one or more antenna(s) 1228 (e.g., one, two, four, or more). In embodiments having multiple antenna(s) 1228, the AP 1218 may perform MIMO, digital beamforming, analog beamforming, beam steering, etc., as has been described.

The AP 1218 may include one or more interface(s) 1230. The interface(s) 1230 may be used to provide input to or output from the AP 1218. For example, an AP 1218 that is a base station may include interface(s) 1230 made up of transmitters, receivers, and other circuitry (e.g., other than the transceiver(s) 1226/antenna(s) 1228 already described) that enables the base station to communicate with other equipment in a core network, and/or that enables the base station to communicate with external networks, computers, databases, and the like for purposes of operations, administration, and maintenance of the base station or other equipment operably connected thereto.

The AP 1218 may include an unavailability period module 1232. The unavailability period module 1232 may be implemented via hardware, software, or combinations thereof. For example, the unavailability period module 1232 may be implemented as a processor, circuit, and/or instructions 1224 stored in the memory 1222 and executed by the processor(s) 1220. In some examples, the unavailability period module 1232 may be integrated within the processor(s) 1220 and/or the transceiver(s) 1226. For example, the unavailability period module 1232 may be implemented by a combination of software components (e.g., executed by a DSP or a general processor) and hardware components (e.g., logic gates and circuitry) within the processor(s) 1220 or the transceiver(s) 1226.

The unavailability period module 1232 may be used for various aspects of the present disclosure, for example, aspects of FIGS. 1-12. The unavailability period module 1232 is configured to generate a UA frame to indicate periods of unavailability.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with an STA or AP as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

The invention claimed is:

1. A method performed by a soft-Access Point (AP), the method comprising:
generating an Unavailability Announcement (UA) frame comprising an unavailability profile, wherein the unavailability profile comprises information indicating an unavailability period for a soft-AP interface of the soft-AP;
sending the UA frame to one or more stations (STAs) associated with the soft-AP interface; and
altering operation of a radio of the soft-AP causing the soft-AP interface to become unavailable during the unavailability period indicated in the unavailability profile.

2. The method of claim 1, further comprising sending the UA frame multiple times before the unavailability period.

3. The method of claim 1, wherein the unavailability profile comprises a start time and a duration for the unavailability period.

4. The method of claim 1, further comprising receiving, from one of the STAs, an initial control frame (ICF) specifying a requested Transmission Opportunity (TXOP) duration, wherein the UA frame is sent in response to the ICF.

5. The method of claim 1, wherein the UA frame is an unsolicited broadcast.

6. The method of claim 1, further comprising receiving, from a first STA, an indication that the first STA is capable of dynamically adjusting a Transmission Opportunity (TXOP) duration and a Physical Protocol Data Unit (PPDU) duration, after a TXOP has been initiated.

7. The method of claim 6, wherein the indication comprises a capability field that is sent during association.

8. The method of claim 6, further comprising determining, when the first STA is not capable of dynamically adjusting, if a requested TXOP duration specified by the first STA in an initial control frame (ICF) overlaps the unavailability period;
if the requested TXOP duration overlaps the unavailability period, setting a duration field of the UA frame to zero to terminate an uplink TXOP; and
if the requested TXOP duration does not overlap the unavailability period, setting the duration field of the UA frame to the requested TXOP duration.

9. The method of claim 6, further comprising setting, when the first STA is capable of dynamically adjusting, a duration field in the UA frame to a time until a start of the unavailability period a requested TXOP duration specified by the first STA in an initial control frame (ICF) overlaps the unavailability period.

10. The method of claim 1, wherein the UA frame includes a field that indicates if the unavailability profile is included.

11. The method of claim 1, further comprising transmitting an indication in beacons about a likelihood of future unavailability periods.

12. A method performed by a station (STA), the method comprising:
receiving, from a soft-Access Point (AP), an Unavailability Announcement (UA) frame comprising an unavailability profile, wherein the unavailability profile comprises information indicating an unavailability period for a soft-AP interface of the soft-AP;
determining, based on the unavailability profile, the unavailability period for the soft-AP interface; and
scheduling uplink frame exchanges so none of the uplink frame exchanges are initiated during the unavailability period.

13. The method of claim 12, further comprising receiving the UA frame multiple times before the unavailability period.

14. The method of claim 12, wherein the unavailability profile comprises a start time and a duration for the unavailability period.

15. The method of claim 12, further comprising sending, to the soft-AP, an initial control frame (ICF) specifying a requested Transmission Opportunity (TXOP) duration, wherein the UA frame is sent in response to the ICF.

16. The method of claim 12, wherein the UA frame is an unsolicited broadcast.

17. The method of claim 12, further comprising sending, to the soft-AP, an indication that the STA is capable of dynamically adjusting a Transmission Opportunity (TXOP) duration and a Physical Protocol Data Unit (PPDU) duration, after a TXOP has been initiated.

18. The method of claim 17, wherein the indication comprises a capability field that is sent during association.

19. The method of claim 17, wherein when the STA is not capable of dynamically adjusting, if a requested TXOP duration specified by the STA in an initial control frame (ICF) overlaps the unavailability period, and a duration field of the UA frame is set to zero to terminate an uplink TXOP if the requested TXOP duration overlaps the unavailability period, and the duration field of the UA frame is set to the requested TXOP duration if the requested TXOP duration does not overlap the unavailability period.

20. The method of claim 17, wherein, when the STA is capable of dynamically adjusting, a duration field in the UA frame is set to a time until a start of the unavailability period when a requested TXOP duration specified by the STA in an initial control frame (ICF) overlaps the unavailability period.
